(19) United States
(12) Patent Application Publication
(10) Pub. No.: US 2007/0104325 A1
(43) Pub. Date: May 10, 2007

(54) Apparatus and method of detecting steganography in digital data

(75) Inventor: Kwang Soo Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignees: Jong In Lim; Sang Jin Lee

(21) Appl. No.: 11/401,383

(22) Filed: Apr. 11, 2006

(30) Foreign Application Priority Data
Nov. 9, 2005 (KR) 2005-0106854

(51) Int. Cl. H04K 1/06

(52) U.S. Cl. 380/37

(57) ABSTRACT

Disclosed is a method of detecting stego data by determining whether a secret message is hidden in digital data. A method of detecting according to the invention includes extracting at least one sample vector using at least one sample of digital data; in at least one high order box including the extracted at least one sample vector, calculating complexity as a number of the sample vectors included each of at least one high order box; classifying at least one high order box as high order box categories according to each complexity; analyzing nonsimilarity between high order box categories according to each complexity of high order box categories; and determining whether a secret message is embedded in the digital data based on the nonsimilarity. Thus, it is possible to exactly determine whether the digital data is stego data or cover data.

### BACKGROUND OF THE INVENTION

1. Field of the Invention

The present invention relates to an apparatus and a method of detecting stego data by determining whether a secret message is hidden in digital data such as still images, audio data, moving pictures, and the like.

2. Description of the Related Art

Steganography is technology for constructing invisible communication by embedding a secret message to be transmitted in a certain area inside general data. Here, the general data having no secret message is called cover data, and data having a secret message is called stego data.

Nowadays, digital multimedia such as still images, audio data, moving pictures, and the like have been used as usual data. Though a typical e-mail or a web, digital multimedia are frequently received and transmitted. Data about such digital multimedia contains a lot of redundant information such as natural noise, whose change makes no difference to the data.

Recently, technologies on embedding the secret message in such redundant information area have been researched, and there are a lot of accessible commercial programs on the web. Most commercial steganographic program employ a least significant bits (LSB) embedding method that embeds a secret message in least significant bits of the digital data. The reason why such the LSB embedding method is used is because LSB of the digital data generally contain information about noise and people cannot recognize whether the LSB are changed or not.

Meanwhile, steganography has a positive aspect in protecting a privacy of individuals but has also a risk to be abused in crime such as terrorism, so that incessant efforts to crack the steganographic data have been made. Steganalysis is technology for detecting a secret message in ordinary data on communication lines by analyzing perceptual or statistical characteristic variation of digital data changed due to steganography. As described above, LSB embedding method is widely used as the commercial steganographic method, so that researches and developments have been preceded in order to analyze digital data changed by LSB embedding method.

There have been disclosed conventional steganalysis methods such as visual attack by westfeld and Pfizmann (IH 1999), closed color pair analysis by Fridrich et al.(ICME 2000), neighbor color analysis by Westfeld(IH 2002), chi-square attack by Westfeld and Pfizmann(IH 1999), Regular-singular analysis by Fridrich et al.(IH 2001), sample pair analysis by Dumitrescu et al.(IH 2003), etc. Basically, such steganalysis methods should discriminate cover data and stego data as exactly as possible. Also, these should be able to detect a secret message even though the embedded secret message has a relatively very small size compared to data containing the secret message.

However, in the aforementioned conventional methods, for example, in the visual attack by westfeld and Pfizmann (IH 1999), many errors arise in operation for discriminating cover data and stego data, and a small sized secret message cannot be detected. Further, for the small sized secret message, there is high probability of misdetecting them.

### SUMMARY OF THE INVENTION

The present invention, therefore, solves aforementioned problems associated with conventional methods by providing an apparatus and a method of detecting steganography in digital data, which uses a high order box model in order to discriminate cover data and stego data exactly and reduce detection errors even if a small sized secret message compared to the digital data is embedded in the digital data.

Further, the present invention provides an apparatus and a method of detecting steganography in digital data, which defines a high order box and uses complexity and/or weight of the high order box in order to exactly determine whether various kinds of digital data are stego data or not

In an exemplary embodiment of the present invention, a method includes: extracting at least one sample vector using at least one sample of digital data; in at least one high order box including the extracted at least one sample vector, calculating complexity on the basis of the number of the sample vectors included in each of at least one high order box; classifying at least one high order box as high order box categories according to each complexity; analyzing nonsimilarity between high order box categories according to each complexity of high order box categories; and determining whether a secret message is embedded in the digital data on the basis of the nonsimilarity.

In another exemplary embodiment of the present invention, the method further includes generating a vector histogram of the extracted sample vectors, and the calculating the complexity includes calculating the complexity of each high order box based on the vector histogram.

In still another exemplary embodiment of the present invention, the method further comprises calculating a weight on the basis of a total sum of the frequency of the sample vectors included in each high order box based on the vector histogram, wherein the nonsimilarity is analyzed by a total sum of the weights.

In yet another exemplary embodiment of the present invention, the determining comprises determining as the secret message is embedded in the digital data when the nonsimilarity is larger than a predetermined threshold. Further, the determining comprises determining as the secret message is not embedded in the digital data when the nonsimilarity is smaller than a predetermined threshold.

In another exemplary embodiment of the present invention, an apparatus comprising: an extracting module for extracting at least one sample vector using at least one sample of digital data, a calculating module, in at least one high order box including the extracted at least one sample vector, for calculating complexity on the basis of the number of the sample vectors included in each of at least one high order box, a classifying module for classifying at least one high order box as high order box categories according to each complexity, an analyzing module for analyzing nonsimilarity between high order box categories according to each complexity of high order box categories, and a discriminating module for determining whether a secret message is embedded in the digital data on the basis of the nonsimilarity.

In still another exemplary embodiment of the present invention, the apparatus further comprises a histogram generating module for generating a vector histogram of the extracted sample vectors, wherein the calculating module calculates the complexity of each high order box based on the vector histogram.

In still another exemplary embodiment of the present invention, the calculating module calculates a weight on the basis of a total sum of the frequency of the sample vectors included in each high order box based on the vector histogram, wherein the nonsimilarity is analyzed by a total sum of the weights.

In still another exemplary embodiment of the present invention, the discriminating module determines as the secret message is embedded in the digital data when the nonsimilarity is larger than a predetermined threshold.

In still another exemplary embodiment of the present invention, the discriminating module determines as the secret message is not embedded in the digital data when the nonsimilarity is smaller than a predetermined threshold.

In still another exemplary embodiment of the present invention, the digital data may include at least any one of digital still image, digital audio data, digital moving picture, text.

And in yet another exemplary embodiment of the present invention, the digital still image may include at least any one of a grayscale image, red, green, and blue (RGB) color image, palette image, discrete cosine transformation (DCT) based compressed image, wavelet based compressed image.

### BRIEF DESCRIPTION OF THE DRAWINGS

The above and other features of the present invention will be described in reference to certain exemplary embodiments thereof with reference to the attached drawings in which:

FIG. 1 shows an operation to determine whether a secret message is embedded in digital data by an apparatus of detecting steganography in the digital data according to an embodiment of the present invention;

FIG. 2 is a schematic block diagram of an apparatus of detecting steganography in digital data according to an embodiment of the present invention;

FIG. 3 shows a third order box model according to an embodiment of the present invention;

FIG. 4 shows complexities in the third order box before/after embedding a secret message in each pixel of a still image based on the third order box model in FIG. 3;

FIGS. 5a and 5b are histograms showing statistics about the third order box model applied to a picture in FIG. 4; and

FIG. 6 is a flow chart showing a method of detecting steganography in digital data according to an embodiment of the present invention.

### DETAILED DESCRIPTION

Hereinafter, preferred embodiments of the present invention will be described with reference to accompanying drawings.

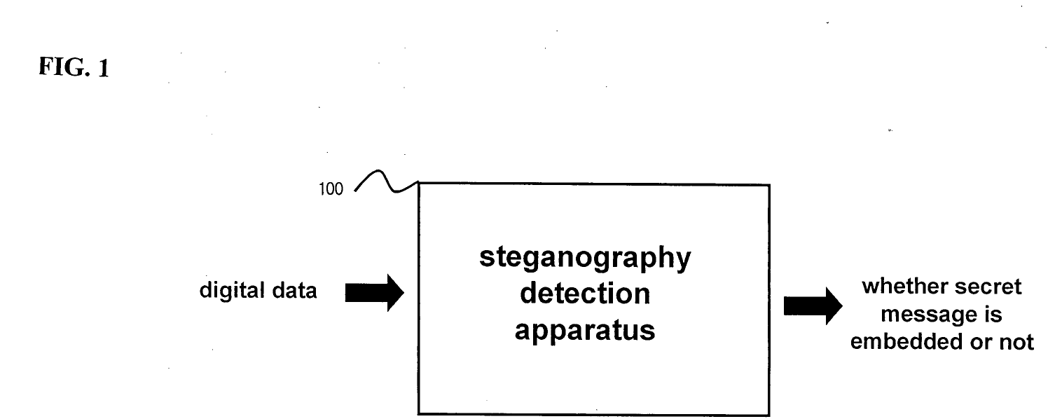

FIG. 1 shows an operation to determine whether a secret message is embedded in digital data by an apparatus of detecting steganography in the digital data according to an embodiment of the present invention.

Referring to FIG. 1, when various digital data are inputted to a steganography detection apparatus 100, the steganography detection apparatus 100 determines whether a secret message is embedded in the inputted digital data or not through a high order box model. Then, the steganography detection apparatus 100 outputs the determined result about whether the inputted digital data is cover data or stego data. Alternatively, when the steganography detection apparatus 100 is provided with a decoder to decode a secret message, the steganography detection apparatus 100 may be configured to extract and output the secret message in the stego data.

The steganography detection apparatus 100 according to the present invention may be achieved by a hardware component or a software application program.

Here, the LSB embedding method is typically used as the method of embedding a secret message in digital data, but the present invention is not limited to the LSB embedding method.

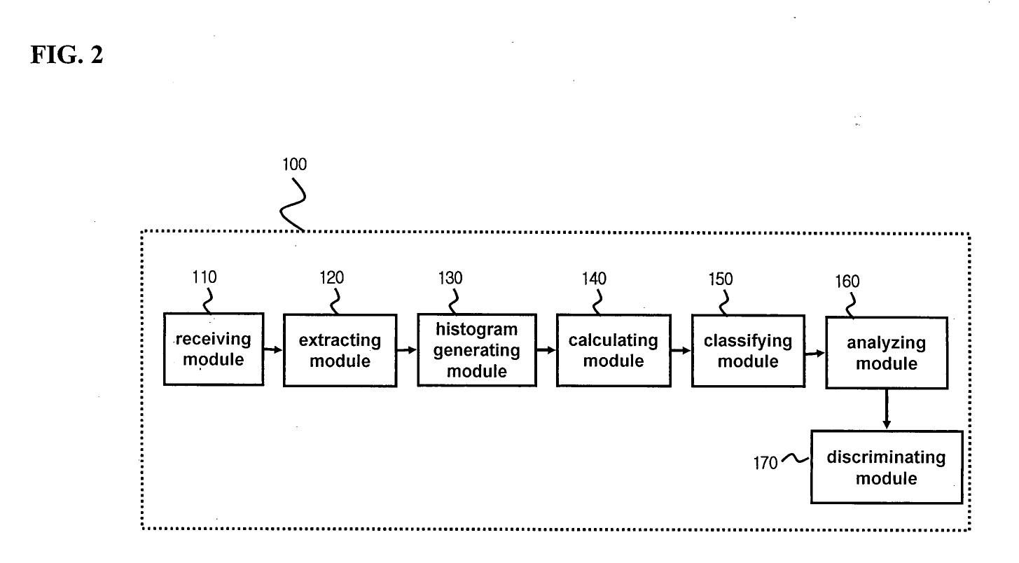

FIG. 2 is a schematic block diagram of an apparatus of detecting steganography in digital data according to an embodiment of the present invention.

The steganography detection apparatus 100 according to the present invention comprises a receiving module 110, an extracting module 120, a histogram generating module 130, a calculating module 140, a classifying module 150, an analyzing module 160, and a discriminating module 170.

The receiving module 110 receives at least one of digital data from the outside.

Here, the digital data includes any data, which is digitalized for transmission, for example, digital still images, digital audio data, digital moving pictures, texts, and the like.

The digital still images include grayscale images, red, green, and blue (RGB) color images, palette images, discrete cosine transformation (DCT) based compressed images, wavelet based compressed images, and the like, but not limited thereto.

The extracting module 120 extracts sample vectors using samples of received digital data.

Here, in case that the digital images are the grayscale images, the samples represent grayscale color values of each pixel. At that time, a sample vector are sequences of neighbor pixel values with respect to one pixel according to a predetermined rule. The sample vectors are preferably extracted from all the pixels as long as the predetermined rule is applicable thereto.

In case that the digital images are the RGB color images, samples are R, G, and B color values. In the case of the R, G, and B color images, the following two methods of extracting the sample vectors can be considered.

First, since an image corresponding to each color component is a monotonescale image, which can be regarded as a grayscale image, the sample vector extracting method used in the grayscale image can be directly applied to the image corresponding to R, G, and B color components of RGB image.

Next, since each pixel itself of the RGB image is represented as three dimensional vector, it can be directly used as the sample vector.

Meanwhile, in case that the digital images are the palette images, samples represent palette index values of each pixel. At this time, after pre-processing procedure such as palette arrangement or the like is performed in consideration of steganographic technology to be used for detecting a secret message, sample vector extracting method applied to the grayscale image is carried out.

In case that the digital images are the DCT based compressed images, samples represent quantization coefficient values of pixels based on DCT. At this time, a sample vector preferably includes coefficient values of frequencies selected according to a predetermined rule based on one frequency within each block, which is selected from neighbor blocks with respect to one DCT blocks according to another predetermined rule. Thus, the sample vectors can be extracted from all the frequencies as long as the predetermined rules are applicable thereto.

Lastly, in the case that the digital images are wavelet based compressed images, samples represent quantization coefficient values of wavelet transform bands. Here, a sample vector is preferably extracted by fifth order sampling using one coefficient of a high frequency band and four related coefficients of a next level band.

The histogram generating module 130 generates a vector histogram hist(.) about the sample vectors extracted from the extracting module 120.

The calculating module 140 calculates complexity and a weight of a high order box on the basis of the vector histogram generated by the histogram generating module 130.

Such a vector histogram provides a frequency of each of the extracted sample vectors.

Here, the high order box B(α, Δ), where arbitrary one point α on Zⁿ is (α₁, α₂, . . . , 60 ₙ), and distance information Δ0 is (Δ₁, Δ₂, . . . , Δₙ), is defined as follows:
B(α, Δ)={(u₁, u₂, . . . , uₙ)εZⁿ: uᵢ=αᵢ or uᵢ=αᵢ+Δᵢ, 1≦i≦n}.

That is, the high order box means a set on Zⁿ, which may include the extracted sample vectors.

Here, (u₁, u₂, . . . , uₙ) means an outmost edge forming an outline of the high order box, and Δᵢ is preferably a positive odd number.

The complexity of the high order box B(α,Δ) is determined through the following complexity function G(.) based on the vector histogram generated by the histogram generating module 130.
G(B(α, 66 ))=|{vεB(α, Δ): hist(v)>0 }|

Here, |.| represents the number of elements of the set, and v means the sample vector included in the high order box B(α, Δ).

That is, the complexity of the high order box B(α, Δ) means the number of sample vectors included in the high order box B(α, Δ).

The weight of the high order box B(α, Δ) is determined through the following weight function F(.) based on the vector histogram generated by the histogram generating module 130.
F(B(α, Δ))=Σ_{vεB(α, Δ)}hist(v).

That is, the weight of the high order box B(α, Δ) means a total sum of the frequency of the sample vectors included in the high order box B(α, Δ).

The classifying module 150 classifies the high order boxes according to categories of the high order boxes.

In more detail, the high order box B(α, Δ) is classified into a category C_{b1, b2 , . . . , bn} defined according to LSB information about each component of α.
C_{b1, b2, . . . , bn}={B(60 , 66 ): αᵢmod2=bᵢ, 1≦i≦n}

Here, bᵢ may be 0 or 1, and the high order box categories may be overall 2ⁿ categories.

That is, the classifying module 150 classifies the high order box B(α, Δ) into overall 2ⁿ categories such as C_{0, 0, . . . , 0}, C_{0,0 , . . . , 1}, C_{1,1, . . . 1}.

Further, the classifying module 150 classifies each of high order boxes included in high order box categories according to the complexity determined by the calculating module 140. In more detail, high order boxes included in an arbitrary high order box category C_{b1 , b2, . . . , bn} are classified into a high order box set C_{b1, b2, . . . , bn [m]={{B(α, Δ):G(B(α, Δ))=m}, whose complexity m is} 0<m<2ⁿ.

For example, high order box categories classified according to their complexity are as follows:
C_{0,0, . . . , 0}=C_{0,0, . . . , 0}[0]∪C_{0,0, . . . , 0}[1]∪. . . ∪C_{0,0, . . . , 0}[2ⁿ].
C_{0,0, . . . , 1}=C_{0,0, . . . , 1}[0]∪C_{0,0, . . . , 1}[1]∪. . . ∪C_{0,0, . . . , 1}[2ⁿ].
. . .
C_{1,1, . . . , 1}=C_{1,1, . . . , 1}[0]∪C_{1,1, . . . , 1}[1]∪. . . ∪C_{1,1, . . . , 1}[2ⁿ].

The above equations are generalized as follows:
C_{b1,b2, . . . , bn}=C_{b1,b2, . . . , bn}[0]∪C_{b1,b2, . . . , bn}[1]∪. . . ∪C_{b1,b2, . . . , bn}[2ⁿ].

The analyzing module 160 compares and analyzes nonsimilarity between high order box categories according to each complexity. That is, the analyzing module 160 compares the nonsimilarity of high order boxes within all of high order box categories for each complexity. In such a comparison, the number of high order boxes included in the high order box set C_{b1, b2, . . . , bn}[m], which is included in each high order box category C_{b1, b2, . . . , bn} and its complexity is m and the total weight of the high order boxes, may be used.

Alternatively, the analyzing module 160 may analyze nonsimilarity on the assumption that the complexities of the high order box categories are similar. Under this assumption, the more accurate result may be achieved.

The nonsimilarity is preferably measured by goodness of fit test, but not limited thereto.

When the steganography by the LSB embedding method is a main object of the detection, such a comparison of the nonsimilarity preferably uses C_{0,0, . . . , 0} and C_{1,1, . . . , 1} of above high order box categories, which is showing the most distinct difference by the LSB embedding steganography, in order to obtain an efficient analysis result.

The discriminating module 170 determines whether a secret message is embedded in digital data or not according to the measured nonsimilarity Further, The discriminating module 170 determines whether the digital data is stego data based on the measured nonsimilarity and a predetermined threshold. That is, the discriminating module 170 determines the digital data is stego data when the measured nonsimilarity is larger than the magnitude of the predetermined threshold. Meanwhile, the discriminating module 170 determines the digital data is cover data when the measured nonsimilarity is smaller than the magnitude of the predetermined threshold.

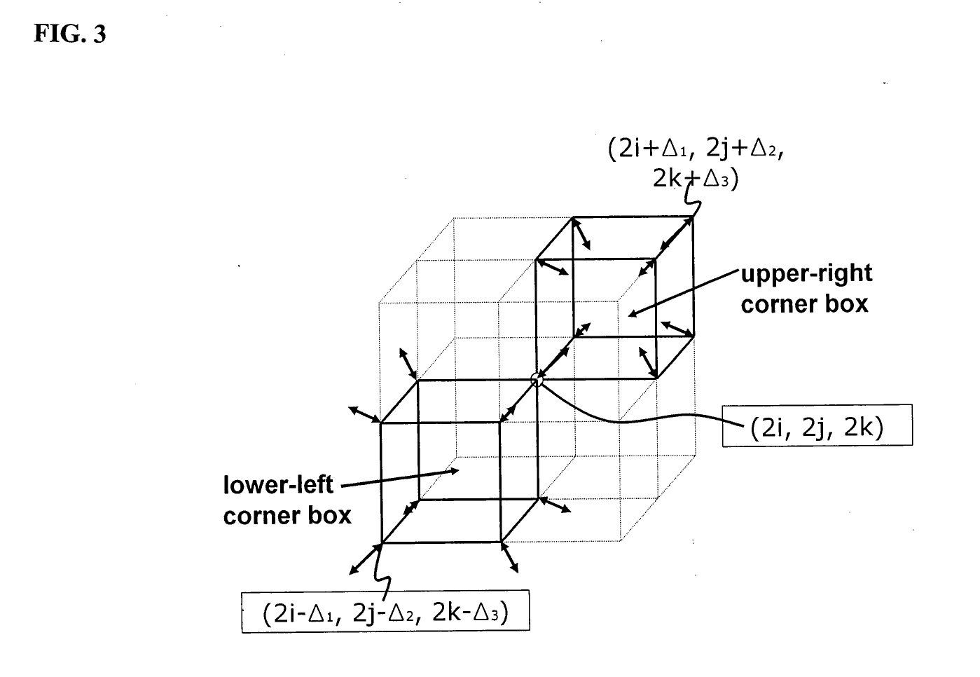

FIG. 3 shows a third order box model according to an embodiment of the present invention.

FIG. 3 illustrates a third order box as an example where each component of a central point (2i, 2j, 2k) is even number. Here, the central point means an arbitrary point of a space defining a third order box.

As illustrated in FIG. 3, the third order box model has boxes, each defined by a central point and distance information (Δ₁, Δ₂, Δ₃).

Here, an upper-right corner box has the farthest edge (2i+Δ₁, 2j+Δ₂, 2k+Δ₃) from the central point, and a lower-left corner box has the farthest edge (2i−Δ₁, 2j−Δ₂, 2k−Δ₃) from the central point.

In addition, a bidirectional arrow on an edge illustrated in each box means a moving direction of a sample vector corresponding to each edge by a secret message embedding. That is, each component of a sample vector of the upper-right corner box moves inward the upper-right corner box because of the secret message embedding. On the other hand, each component of a sample vector of the lower-left corner box moves outward the lower-left corner box because of the secret message embedding.

Although not shown in FIG. 3, when each component of the central point is odd number, characteristics of an upper-right corner box and a lower-left corner box are interchanged. That is, each component of a sample vector of the upper-right corner box moves outward the upper-right corner box because of the secret message embedding. On the other hand, each component of a sample vector of the lower-left corner box moves inward the lower-left corner box because of the secret message embedding.

As each component of a sample vector moves, the complexity of the corresponding box is changed.

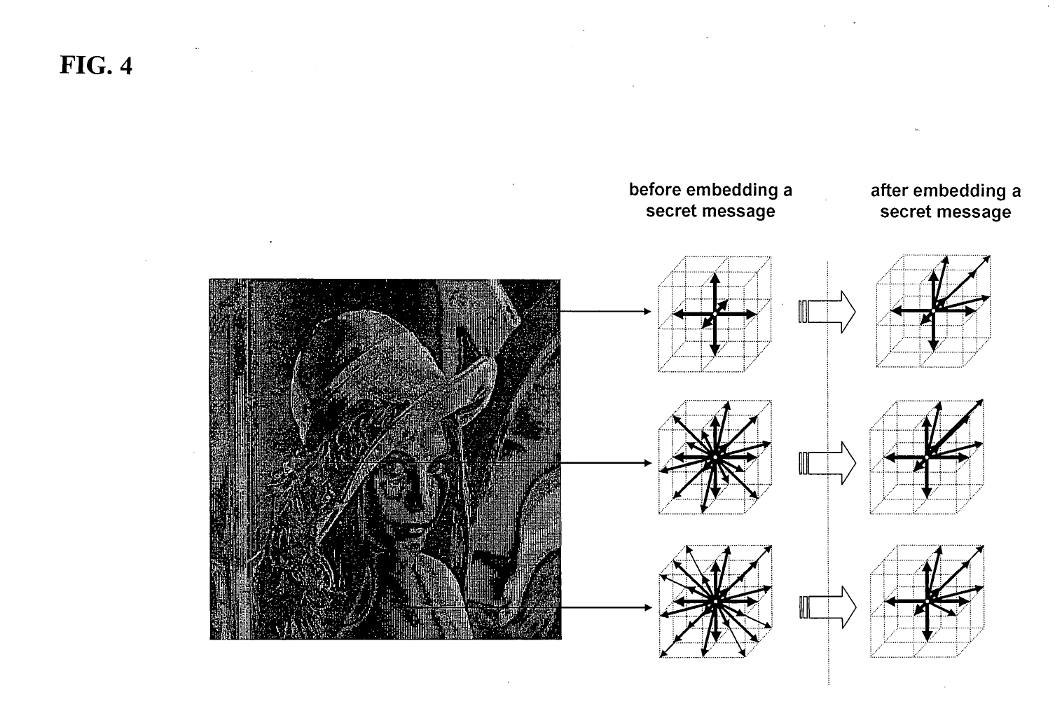

FIG. 4 shows complexities in the third order box before/after embedding a secret message in each pixel of a still image based on the third order box model in FIG. 3.

Referring to FIG. 4, the complexity of the third order box is changed as shown in this figure after a secret message is embedded.

As described referring to FIG. 3, because sample vectors in the lower-left corner box move outward the lower-left corner box by the secret message embedding, and the sample vectors in the upper-right corner box move inward the upper-right corner box by the secret message embedding.

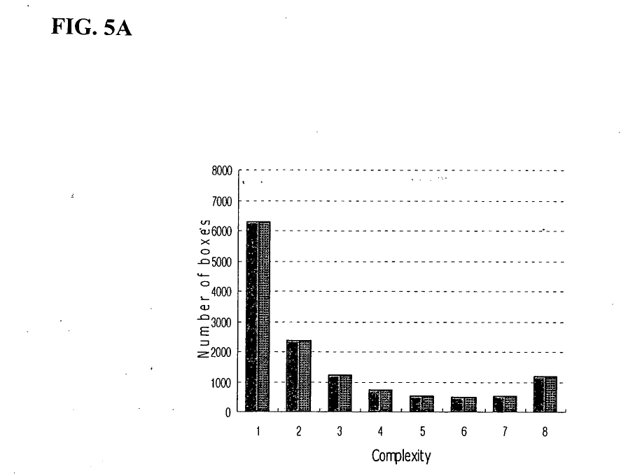

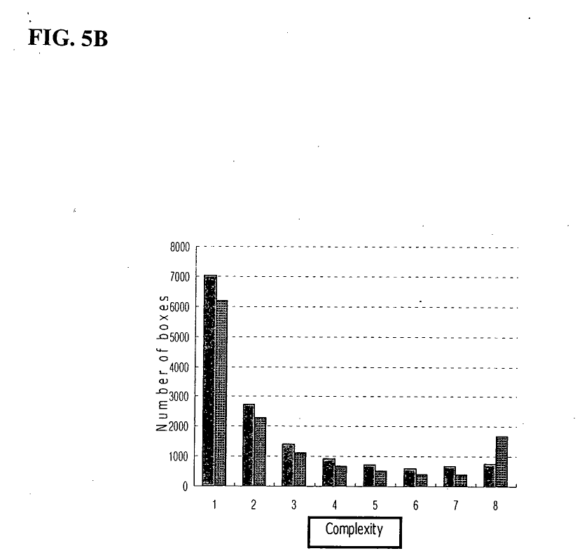

FIGS. 5a and 5b are histograms showing statistics about the third order box applied to a picture in FIG. 4.

FIG. 5a is a histogram showing statistics about the third order box before. the secret message is embedded, and FIG. 5b is a histogram showing statistics about the third order box after the secret message is embedded. Each lateral axis of these figures means complexity of the third order box, and each longitudinal axis of these figures mean a number of the third order boxes corresponded to each complexity.

In FIGS. 5a and 5b, two bar graphs per complexity are illustrated. Here, the left one of two bar graphs per complexity corresponds to the lower-left corner box, and the right one corresponds to the upper-right corner box. As shown in FIGS. 5a and 5b, for example, when a complexity is of 8, the number of the third order box after the secret message embedding is increased compared to that of the third order box before the secret message embedding. Therefore, the present invention is implemented based on such a theoretical basis.

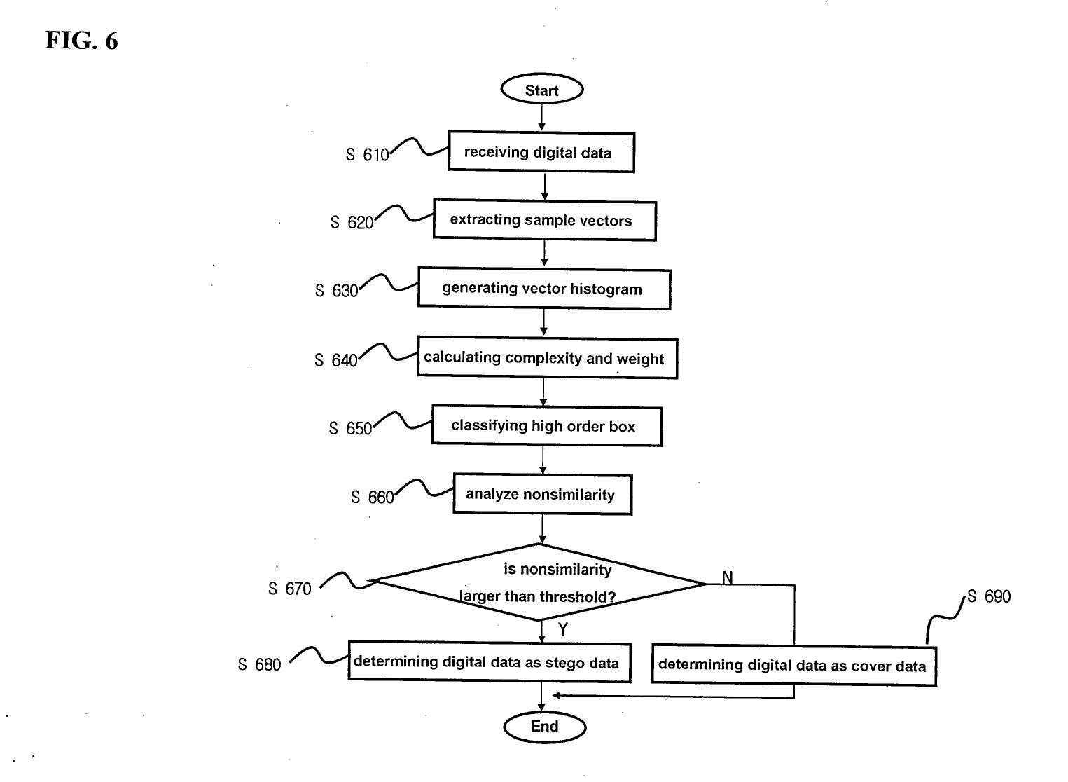

FIG. 6 is a flow chart showing a method of detecting steganography in digital data according to an embodiment of the present invention.

First, at operation S610, at least one of digital data is received from the outside. Digital data may include digital still images, digital moving pictures, digital audio data, and the like, and the digital still images may include grayscale images, RGB color images, palette images, DCT based compressed images, wavelet based compressed images, and the like.

Then, at operation S620, sample vectors are extracted using samples of the received digital data. These sample vectors will be extracted depending on the type of the digital data.

At operation S630, the vector histogram is generated based on the extracted sample vectors.

Then at operation S640, the complexity and the weight of the third order box is calculated based on the vector histogram. Here, the complexity means the number of sample vectors included in a high order box, the weight means the total sum of the frequency of the sample vectors included in the high order box. In addition, the high order box means a set on Zn, which may include the extracted sample vectors.

At operation S650, each high order box is classified as categories according to the complexity.

Although such a classifying step includes classifying high order boxes as high order box categories, classifying high order boxes as high order box categories may be performed after the operation S630 of the histogram generating step.

Then, at operation S660, nonsimilarity for each complexity of high order box categories is analyzed.

At operation S670, whether a secret message is embedded in digital data is determined based on the measured nonsimilarity.

In other words, on S680, the digital data is determined as stego data when the measured nonsimilarity is larger than a predetermined threshold. Meanwhile, on S690, the digital data is determined as the cover data when the measured nonsimilarity is smaller than a predetermined threshold.

Although both of the complexity and the weight are used as a method of determining whether the digital data is stego data or not, the complexity only may be used without calculating the weight.

As described above, an apparatus and a method of detecting steganography in digital data according to the present invention is a new method and has advantages in discriminating cover data and stego data exactly and determining stego data exactly regardless of an embedding ratio of stego data to the digital data.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A method comprising:
extracting at least one sample vector using at least one sample of digital data;
in at least one high order box including the extracted at least one sample vector, calculating complexity on the basis of the number of the sample vectors included in each of at least one high order box;
classifying at least one high order box as high order box categories according to each complexity;
analyzing nonsimilarity between high order box categories according to each complexity of high order box categories; and
determining whether a secret message is embedded in the digital data on the basis of the nonsimilarity.

2. The method according to claim 1, further comprising generating a vector histogram of the extracted sample vectors,
wherein the calculating the complexity comprises calculating the complexity of each high order box based on the vector histogram.

3. The method according to claim 2, further comprising calculating a weight on the basis of a total sum of the frequency of the sample vectors included in each high order box based on the vector histogram,
wherein the nonsimilarity is analyzed by a total sum of the weights.

4. The method according to claim 1, wherein the determining comprises determining as the secret message is embedded in the digital data when the nonsimilarity is larger than a predetermined threshold.

5. The method according to claim 1, wherein the determining comprises determining as the secret message is not embedded in the digital data when the nonsimilarity is smaller than a predetermined threshold.

6. The method according to claim 1, wherein the digital data includes at least any one of digital still image, digital audio data, digital moving picture, text.

7. The method according to claim 6, wherein the digital still image includes at least any one of a grayscale image, red, green, and blue (RGB) color image, palette image, discrete cosine transformation (DCT) based compressed image, wavelet based compressed image.

8. An apparatus comprising:
an extracting module for extracting at least one sample vector using at least one sample of digital data;
a calculating module, in at least one high order box including the extracted at least one sample vector, for calculating complexity on the basis of the number of the sample vectors included in each of at least one high order box;
a classifying module for classifying at least one high order box as high order box categories according to each complexity;
an analyzing module for analyzing nonsimilarity between high order box categories according to each complexity of high order box categories; and
a discriminating module for determining whether a secret message is embedded in the digital data on the basis of the nonsimilarity.

9. The apparatus according to claim 8, further comprising a histogram generating module for generating a vector histogram of the extracted sample vectors,
wherein the calculating module calculates the complexity of each high order box based on the vector histogram.

10. The apparatus according to claim 9, wherein the calculating module calculates a weight on the basis of a total sum of the frequency of the sample vectors included in each high order box based on the vector histogram,
wherein the nonsimilarity is analyzed by a total sum of the weights.

11. The apparatus according to claim 8, wherein the discriminating module determines as the secret message is embedded in the digital data when the nonsimilarity is larger than a predetermined threshold.

12. The apparatus according to claim 8, wherein the discriminating module determines as the secret message is not embedded in the digital data when the nonsimilarity is smaller than a predetermined threshold.

13. The apparatus according to claim 8, wherein the digital data includes at least any one of digital still image, digital audio data, digital moving picture, text.

14. The apparatus according to claim 13, wherein the digital still image includes at least any one of a grayscale image, red, green, and blue (RGB) color image, palette image, discrete cosine transformation (DCT) based compressed image, wavelet based compressed image.
